(19) United States
(12) Patent Application Publication
(10) Pub. No.: US 2019/0260826 A1
(43) Pub. Date: Aug. 22, 2019

(54) P2P VIDEO COMMUNICATION WITH A THIRD-PARTIES

(71) Applicant: Artem Gurtovoy, Moscow (RU)

(72) Inventor: Artem Gurtovoy, Moscow (RU)

(21) Appl. No.: 16/280,192

(22) Filed: Feb. 20, 2019

Related U.S. Application Data
(60) Provisional application No. 62/633,212, filed on Feb. 21, 2018.

(51) Int. Cl. H04L 29/08

(52) U.S. Cl. CPC H04L 67/104

(57) ABSTRACT

A system enabling a direct exchange of streaming media between participants within a peer-to-peer network. The system includes a plurality of network nodes that transmit media-messages to one another in node-to-node media-message exchanges defined as media-chats and a server operating an application programming interface (API) for receiving and processing a media-message transmitted by a first network node to a second network node, and based on the processing, directing the media-message to the second node to establish a media-chat therebetween and for monitoring and managing a media-chat state defined by respective sets of parameters for each of the network nodes. A synchronization of the respective media-chat states a direct streaming media exchange therebetween. Respective node accounts associated with the first network node and the second network node are charged for a time in which said nodes participate in the synchronized media-chat.

### CROSS-REFERENCE TO RELATED APPLICATION

This application claims priority under 35 USC § 119(e) from U.S. Provisional Patent Application No. 62/633,212, filed Feb. 21, 2018, the contents of which provisional application are incorporated herein by reference.

### BACKGROUND OF THE INVENTION

The invention relates broadly to live media streaming and more particularly, to a method of managing media chats and streaming media transfers between nodes in a peer-to-peer (P2P) network, wherein member nodes transmit media messages to initiate, accept and/or terminate media-chats in cooperation with a network service application programming interface (API). The API monitors the media chat states of and between the nodes (client or user applications), characterized by a set of parameters such that in a synchronized media chat state, a first and a second node (client applications) are able to directly exchange a media (e.g., streaming media) therebetween, independent of the API.

Peer-to-Peer (P2P) networks are known. In their 2007 paper, NETWORK ARCHITECTURES FOR LIVE PEER-TO-PEER MEDIA STREAMING, Ghoshal, et al., investigated the benefits and limitations of peer-to-peer (P2P) media streaming networks. As Ghosal, et al. explain therein, prior to P2P networks, the client-server model and the content distribution network (CDN) along with IP multicast were the most desirable solutions to support media streaming, but lost ground to the widespread deployment of P2P networks due to unique characteristics of the P2P networks. That is, a major advantage to deployment of P2P networks is that each peer contributes its own resources to the network, resulting in an increase in the amount of overall resources of the network, such as bandwidth, storage space, and computing power. P2P networks overcome the bottleneck problem at the server in a client-server model, where the single server must have enough resources to support all simultaneous clients. A CDN alleviates the same bottleneck problem by introducing more dedicated servers at geographically different locations, but results in expensive deployment and maintenance. And while IP multicast has good scalability in theory, its actual deployment across the Internet is limited.

There are two major types of P2P network protocols: P2P file downloading protocols and P2P media streaming protocols. P2P media streaming protocols are motivated by the work on P2P file downloading protocols. But while they both establish a P2P network of users, they are significantly different. Media streaming has a tight time constraint in that the playback starts soon after the streaming begins, and the stream should be played back continuously, whereas file downloading has no such requirement on the downloading order of different blocks of a file. In addition, using file downloading protocols, the file is accessed by a user only after the whole file has been downloaded. These differences required improvements to the architectural design of P2P file downloading protocols to readily address the timing constraints and to provide good media quality for P2P media streaming protocols.

Live media streaming, and stored media streaming also known as Video on Demand (VoD) are the two broad categories in P2P media streaming networks. In VoD, a user jumps to any point in time of a pre-recorded media stream. The sending rate of a media source in stored streaming (VoD) is limited only by the available bandwidth. In live media streaming, the live media stream is encoded on the fly and sent to all users, where the sending rate of a media source is limited by both the media encoding rate and the available bandwidth.

Relatively recently, companies like Streamroot and Peer5 have developed peer-accelerated streaming technology that leverage WebRTC based Peer-To-Peer networks (to offload CDNs), touted to allow streaming capacity to grow proprtionally with streaming demand. WebRTC is a standard developed by Google which allows interconnectivity between browsers through direct connections. WebRTC is a free, open project that provides browsers and mobile applications with real-time communications (RTC) capabilities via simple APIs. The well known video conference software Hangouts is completely based on WebRTC. When starting a video conference, the video data travels “from browser to browser.”

A major problem with conventional P2P networks, however, is that there is no protocol known that enables direct media streaming between nodes (client or user applications) in a P2P network in a way in which the streaming media is monitored to effect charging the media stream recipients, and which prevents cracking media streams to avoid charges.

### SUMMARY OF THE INVENTION

The present invention provides a method of managing chats and exchange(s) of streaming media between nodes (e.g., client applications) in a peer-to-peer network, which overcomes the shortcomings of the prior art.

The invention relates broadly to live media streaming and more particularly, to a method of managing chats and streaming media transfers between nodes in a peer-to-peer (P2P) network, wherein member nodes transmit media messages to initiate, accept and/or terminate media-chats in cooperation with a network service application programming interface (API). The API monitors the media chat states of and between the nodes (client or user applications), characterized by a set of parameters such that in a synchronized media chat state, a first and a second node (client applications) are able to directly exchange a media (e.g., streaming media) therebetween, independent of the API.

The invention is implemented in any client-side applications (nodes) that support WebRTC protocol and are able to communicate via HTTP with the API service. In a preferred embodiment, the invention is implemented as a client-side application. That is, a web application runs in the browser environment (common website), avoiding the need to install any additional software to client machines. The applications are installed by the clients on Apple and Google mobile platforms (iOS, Android). Clients have to install those applications (mobile app) on their smartphones or tablets in a way provided by platforms (Apple Store, Google Play).

In an embodiment, the invention provides a method of managing chats and exchange of streaming media between nodes in a peer-to-peer network comprising a plurality of network nodes, whereby a server-side application programming interface (API) receives a media-message transmitted by a first node to a second node to establish a media-chat therebetween, manages or monitors signals exchanged between the nodes to establish a synchronized media chat state, defined by respective sets of parameters, after which the nodes may directly (without API control) exchange streaming media therebetween, which is chargeable to financial accounts associated with the nodes, until one of the parameters defining the media chat state of one of the first and the second nodes changes, thereby rendering the node states out of synchronization.

The invention also includes a computer program comprising a set of computer-readable instructions for carrying out steps or acts of the method, when the computer-readable instructions are processed by a server on the server side, to implement the API, and communicate with the client-side applications operational on the network nodes and a non-transitory computer-readable storage medium for storing the set of computer-readable instructions. The invention also includes a system or network comprising the server operating the API and the network nodes, for carrying out the method.

In the inventive method and system, an exchange of streaming media (i.e., media flow) is implemented directly between network nodes (users of the service provided by the API) are in a synchronized state, i.e., once an exchange of media messages between the nodes establish a synchronized media chat state. The client-side applications (nodes), using the API service, exchange information on the state of incoming and outgoing media streams (reception, transmission), i.e., the media chat state. Based on these chat states, the API writes off service payment funds for clients receiving streaming media.

Media-messages are defined herein as “small,” as they only contain description of the media-chat state. The following is a simplified example of media-chat establishing process among two clients:

A is an “initiator” and B is an “acceptor” of media-chat.

| A (message): | |
|---|---|
| Sender ID | A |
| Recipient ID | B |
| In | 1 |
| Out | 1 |
| Network | network-related object |

The small message describes the intention of node A to start a media-chat with node B using two-way media streams exchange (in: 1, out: 1). As defined herein, a “media-stream exchange” between A and B is a technical ability for these nodes to “see” and “hear” each other. Put another way, the message means A wants to see and hear B while B is able to see and hear A. After this message is sent, the client-side application A is transferred to a state defined as (pending-in: 1, pending-out: 1), while the proposed recipient B has no state yet (in: 0, out: 0). This is simplest example of clients in unsynchronized states.

A pending-x state means an intention to transit to state “x” right after the other side does so (i.e., the client with the pending-x states is not transmitting/receiving yet but will when the other application does begin). The service API processes the messages and ensures that A has enough credits (ability to pay for service). Otherwise it will decline A's request to exchange messages with B. When client application B has received this message (from A) and applies synchronization rules, B's state is transferred to the state (pending-in: 1, pending-out: 1) and from B's perspective, client application A is in the state (in: 1, out: 1).

The actual result of applying rules is (transition-in: 1, transition-out: 1). Transition-x state means intention to transit to state x while the user's/client's explicit approval is mandatory (i.e., some approval button should be pressed by the client to evidence acceptance). In this case, B should ‘accept’ the incoming request from A (see below). After approval is received, client application B is transferred to the state (in: 1, out: 2). At this point from B's perspective, its state is synchronized with A and no other state-synchronization actions are required. Because its state was changed, node B sends a message to node A. Because the received message contains a network object and there is no WebRTC connection between nodes A and B, node B's network-related object also is included in the reply.

| B (message): | |
|---|---|
| Sender ID | A |
| Recipient ID | B |
| In | 1 |
| Out | 1 |
| Network | Network-related object |
| | (Part of WebRTC Protocol) |

When node A has received this reply from node B, A's state was still defined as (pending-in: 1, pending-out: 1). A's state therefore is unsynchronized with B's state (in: 1, out: 1), as was described in that message. Consequently, A makes a transition to state (in: 1, out: 1) according to synchronization rules table (see below). At this moment, the applications/nodes (A, B) began establishing WebRTC connection and then media-chat is started.

Once the media chat states of two nodes (for example, a first node A and a second node B, or a local and a remote node) are synchronized, the media stream may be exchanged independent of the API. But if the conditions of the media streams transmitted by the application of one node (user) are different from the state of the other node (user), for example, based on a detected change of the media chat state of one (users), there is no synchronization and consequently, the nodes will not transmit streaming media. In this way, closing or opening of media streams is managed and an unauthorized change (cracking) of one of the nodes/applications will not lead to the possibility of a free use of the service on the account of the application of the second node.

As used herein, the term service describes a combination of software (the server-side application that operates the API) and hardware (the server), for providing the users with the inventive functions and capabilities disclosed herein.

The term user means a user with an electronic device such as a laptop computer, a desktop computer, a tablet computer, a smartphone, etc., and is referred to interchangeably herein as node, network node, node member, and client or client-side application. A user-side or client-side application means the software application operational at a user (node) location, such as the browser, mobile application, or other software that is operational on the user's device (node).

Media stream is used herein to describe a stream of video and audio information transmitted over the Internet to be converted by the user-side applications at the individual user nodes to the video images and sound presented on the user's device (node).

### DESCRIPTION OF THE DRAWINGS

Further features and advantages of the invention will become apparent from the description of embodiments that follows, with reference to the attached figures, wherein:

FIG. 1 depicts a prior art peer-to-peer (P2P) network;

FIG. 2 depicts a peer-to-peer (P2P) network constructed according to the invention;

FIG. 3 depicts a signal flow sequence or exchange between two client applications; and

FIG. 4 depicts a diagram of transitions between signal states of an RTC connection.

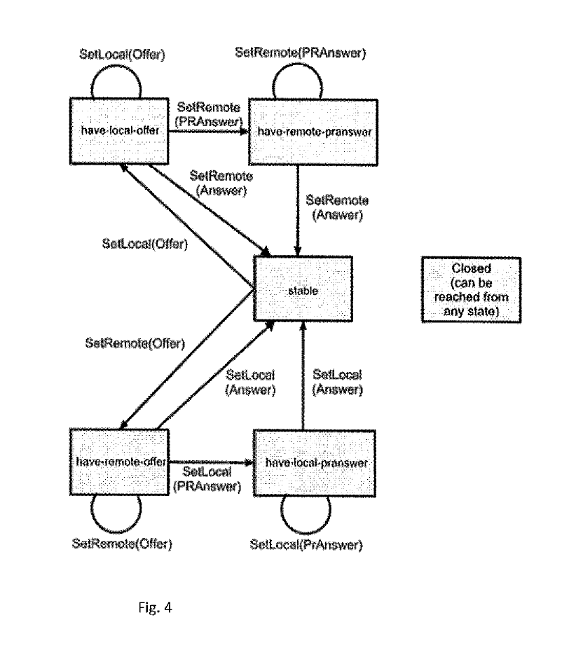

### DETAILED DESCRIPTION OF THE INVENTION

The following is a detailed description of example embodiments of the invention depicted in the accompanying drawings. The example embodiments are presented in such detail as to clearly communicate the invention and are designed to make such embodiments obvious to a person of ordinary skill in the art. However, the amount of detail offered is not intended to limit the anticipated variations of embodiments; on the contrary, the intention is to cover all modifications, equivalents, and alternatives falling within the spirit and scope of the present invention, as defined by the appended claims.

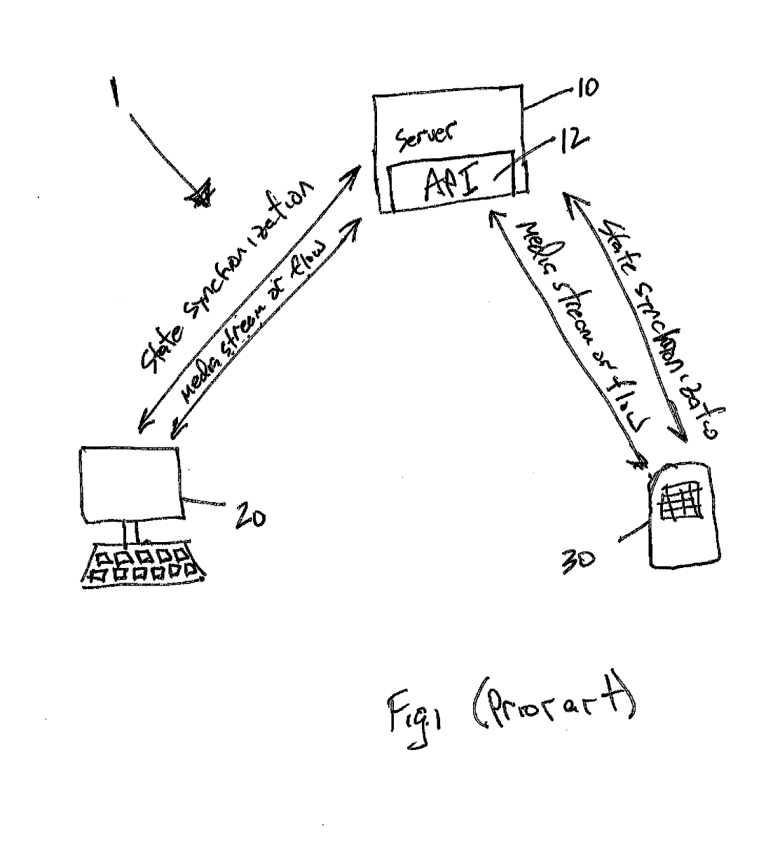

FIG. 1 depicts a prior art network 1. As shown, network 1 includes a service-side server 10 that operates an application programming interface (API) 12. The API 12 exchanges signals including messages with a node embodying a desktop computer 20 and another node embodying a mobile device 30 through the Internet (routers and cloud not directly shown for simplicity). State information defines a state of message exchanges and media stream between the API 12 and the mobile device 30 and between the API 12 and the desktop computer 20. There is no independent exchange of streaming media between network member nodes, i.e., desktop computer 20 and mobile device 30. Any streaming media must be downloaded from the API 12, which is problematic if the demand for streaming media is high, which can result in bottlenecking or delays in receiving streaming data in real time.

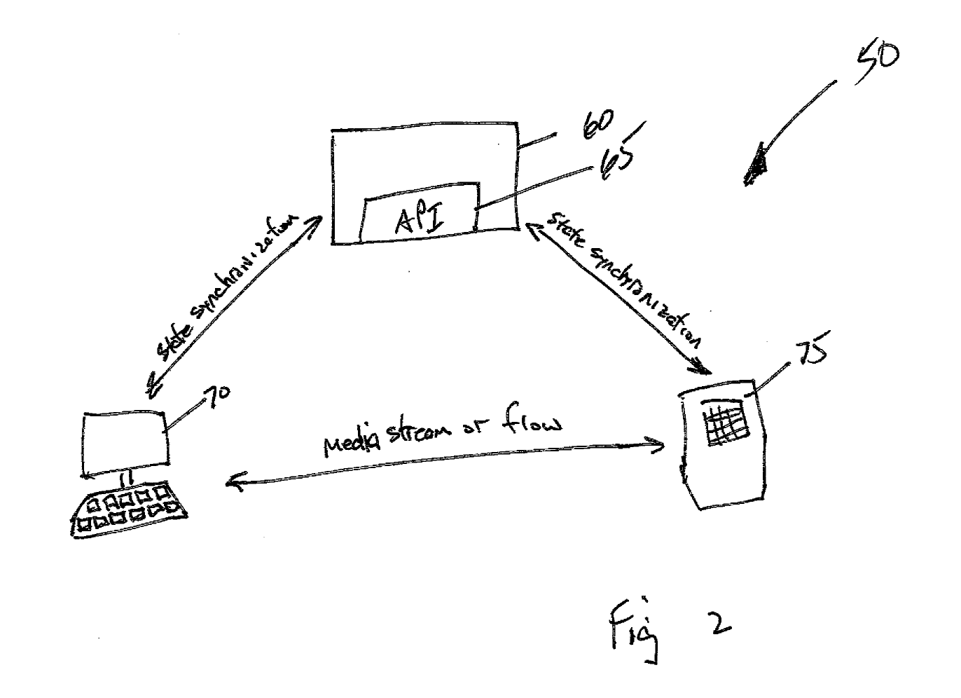

FIG. 2 depicts a peer-to-peer (P2P) network 50 constructed according to the present invention. As shown, P2P network 50 includes a service-side server 60 that operates an application programming interface (API) 65. The API 65 exchanges media messages with client-side applications running on the user/node devices, such as a desktop computer 70 and a mobile device 75 through the Internet (routers and cloud not directly shown for simplicity). Please note that the network nodes are described as mobile device 75 and desktop computer 70 for exemplary purposes only, that the inventive network is not limited to any numbers of node members, which may operate any known electronic device capable to sending and receiving streaming media.

State information defines a state of media messages exchanged. In the inventive network 50, as shown, however, there is no media flow between the API 65 and the user application program running mobile device 75 and between the API 65 and the user application program running on desktop computer 70. Instead, the network nodes (mobile device 75 and desktop computer 70) first establish a media-chat with each other via the API 65. Each node has a certain set of associated media-chat parameters, defining a state. The nodes may initiate a media-message exchange with other nodes, and after a signaling exchange according to the inventive protocol, two nodes may be synchronized, as reflected by their respective set of media-chat parameters, i.e., the respective media chat states are synchronized.

In a synchronized state, two nodes may exchange streaming media directly, independently of the API. The API monitors the media chat to determine charges that need to be made against an account of one or both of nodes exchanging media streams, based on the time period for which the nodes are synchronized and exchanging the streaming media. The media streams are exchanged between the two synchronized nodes until there is a change of state of one of the parameters of one of the nodes, such that the respective nodes are said to be out of synchronization. The media stream between the unsynchronized nodes then ceases. Because the ability to exchange streaming media is limited to nodes that are synchronized, as reflected by the media chat parameters, unsynchronized nodes are not able to receive streaming media, preventing occurrence of cracking. First, relying on a media chat to synchronize nodes and then enabling an independent, direct exchange of streaming media therebetween results in many advantages over prior art media methods of distributing streaming media. For example, the inventive method, system and network save on transmitted network traffic, cutting down on required server-side bandwidth in view of a consequential decrease of load on the API-service and a decrease in delays during translation of media-streams (once received at a node module or device). Perhaps as importantly, protection is preserved against charge-less use of the service (i.e., cracking) in case of unauthorized change in one of applications (server-side or user-side), since synchronization of states and tariffication are performed by means of the API.

The inventive method, system and network that implement the method rely on an inventive data structure referred to herein as media-message, which is defined as follows:

Media-message Table

| Name | Type | Description |
|---|---|---|
| sender-id | number | Sender identification number |
| recipient- | number | Recipient identification number |
| id | | |
| In | bit \|\| | State of incoming stream or an initiative for its |
| | null | update (1—switched on, 0—switched off, |
| | | null—not determined) |
| Out | bit \|\| | State of outgoing stream or an initiative for its |
| | null | update (1—switched on, 0—switched off, |
| | | null—not determined) |
| network? | object | Network level of media-messages |

| Name | Type | Description |
|---|---|---|
| sdp? | object | WebRTC |
| | | session description |
| ice? | array | ICE candidates array |
| phase | number | Phase of connection |
| | | establishment (0—test |
| | | connection establishing, |
| | | 1—main connection) |
| browser? | string | Browser identifier |
| | | (Chrome, Firefox) |

| | | |
|---|---|---|
| evidence? | dataURI | Evidence of input translation. |
| | | A picture or a video-clip of incoming stream |
| | | is taken as a value. Recommended size - |
| | | 1/10 of the original. |
| hangup-in? | datetime | Breaktime of incoming stream |
| hangup- | datetime | Breaktime of output flow |
| out? | | |
| revision? | number | Revision incremented on change of state |
| resync? | bit | Unscheduled media-message |

A media-message is transmitted to a client with an event event.dialogs.media.messages.added. Please note that “client,” “user, “node,” client application and client-side application are interchangeably herein. A media-message with a non-empty network property functions as initial message in a media-chat, i.e., it acts to initiate a media-chat. A media-message indicating that both media streams are in an “off” state is called final.

The inventive method, system and network that implement the method also rely on an inventive data structure referred to herein as media-chat. Media-chat is defined as an exchange or sequence of media-messages with activated state of any stream between two users (i.e., nodes), i.e., on the client-side between the user nodes.

For streaming media, media-chat is available for those client-side nodes that have technical capability to start a media-chat. To start a media-chat, one user (for example, a first node) takes initiative towards another user (for example, a second node), where the other user (second node) accepts the initiated media-chat, Users (nodes) may activate a function to accept an input initiative in automatic mode. During a media-chat, any of the participants may switch one of the streams or deactivate both media streams (during a synchronized chat, the media stream may from between the two nodes, in both directions), which will terminate the media-chat. Any exchange with media-messages is chargeable, with time-based billing that is monitored by the API. Initiators of a media-chat may be referred to as a first node or local user (node), where the second participant may be referred to as the second node or remote user (node).

A media-chat state for each participant in a media-chat is characterized by the following set of parameters:

Table of Chat State Parameters

| Name | Values | Description |
|---|---|---|
| in | 0—off | Incoming stream state |
| | 1—on | |
| out | 0—off | Outgoing streamstate |
| | 1—on | |
| pending-in | 0—absence of | Initiative on incoming |
| | initiative | stream activation |
| | 1—initiative | |
| pending-out | 0—absence of | Initiative on incoming |
| | initiative | stream deactivation |
| | 1—initiative | |
| transition-in | 0—no request | Request for transition to switched |
| | 1—request available | on state of incoming stream |
| transition- | 0—no request | Request for transition to switched |
| out | 1—request available | on state of output stream |

A deactivated state of both streams (streams to and from a pair of nodes) corresponds to an absence of a media-chat. As used herein, pending and transition will mean pending-in (transition-in) for an incoming media stream or flow and a pending-out (transition-out) for output media stream or flow.

The state of media-chats of both participants (i.e., a first and a second network node) is synchronized, upon the following conditions satisfied:

local.in =remote.out
local.out=remote.in
local.revision=remote.revision
pending-in =0|remote.resync=0
pending-out=0|remote.resync=0

When one of conditions is not satisfied, the state of the media-chat may be said to be out of synch. A synchronization of states happens via exchange of media-messages. A state of a media-chat is called active, under the following condition: local.in|local.out

Incoming Message

At receipt of a media-message by the API, a check is made as to media-chat states. If the check reveals that the media-chat states of the participants (i.e., a first node and a second node) are unsynchronized, a local synchronization is performed under the following rules equal for both media streams. Local synchronization is a process of applying the synchronization rules table while processing incoming messages in case of unsynchronized states for media-chat participants (as described in detail). The synchronization rules are:

Synchronization Rules Table

| | |
|---|---|
| in | out |

| local | remote | pending | resync | transition | result |
|---|---|---|---|---|---|
| 1 | 0 | 0 | | 0 | 0 |
| 0 | 1 | 0 | | 1 | 0 |
| 0 | 1 | 1 | | 0 | 1 |
| 1 | null | 0 | 1 | 0 | 1 |
| 0 | 0 | 1 | 1 | 0 | 0 |

“In” as used in the Synchronization Rules Table means “current state” (incoming parameter) and “out” means the state after applying the rules or result-state (outgoing parameter). It is nothing with “in” and “out” parameters in media chat state description The rules are applied to each “in” and “out” channel of the state, as should be clear from the following example;

Application or user node B receives a message (in: 1, out: 1) while it is in “no” state (in: 0, out: 0).

First, rules are applied for “in” channel. B's state of the “in” channel is 0, and from B's perspective. A's state of “in” channel is 1 (as described in message B is processing).

B's state from B's perspective is “local” and A's state from B's perspective is “remote.” Again, B processes the message and for “in” channel, B's state is “0” and A's state is “1.” In other words, from B's perspective, local=0 and remote=1.

As should be clear, the result of applying the rule from the synchronization rules table is “transition,” since same are applied to “in,” channel B is transferred to (transition-in:1) state. The same applies to the “out” channel, i.e., (local=0; remote=1), thus the complete result is (transition-in: 1; transition-out: 1) Put another way, transition-x results in a user's approval request, which upon approval (when the user or client actuates a “accept” or “approved” button or switch), the transition state becomes the (normal) state (in:1; out: 1). And because B's state has changed, B sends a message to A with its state (in:1; out: 1).

Upon receipt, node A processes the reply from node B. That is, A's state is still (pending-in:1, pending-out: 1) and from A's perspective B's state is (in:1, out: 1) as described in the message being processed. Thus, as the states are unsynchronized, the synchronization rules must be applied.

For each channel, node A's state is “pending” and node B's state is 1. In other words, from node A's perspective: local=0, pending=1, and remote=1. Please recall that if local=0, neither ‘in’ or ‘out’ channel is in the “1” state yet because the process is waiting for a reply from the other side (i.e., application or node)′ if pending=1, the channel's state (in and/or out) I sent=1 and waiting for the reply; and if remote=1, the user application has received and is now processing a message from the other application with the channel's state=1.

The result of applying this rule is state 1 for each channel, thus the states of nodes or client applications A and B became synchronized (in: 1, out: 1) and both applications start transmitting and receiving media streams.

Please note that the last rule (001100) also is a synchronization even though a state before and after it equals to 0. Null in remote means an undetermined state. A null state will not change current states of a local media-chat in any way.

At synchronization into a state equal to pending, or at synchronization into a state 0, pending will be set to 0 value.

User Action

Output initiative on state transition (i.e., a change of a pending parameter) may be a result of user action, or a confirmation of an input initiative (change of a transition parameter). This reflects a user's action to change a current synchronized state, e., to start a chat, to stop transmitting while still receiving, etc. Such action leads to the pending node or client application states described herein.

In case of an input initiative confirmation, a transition parameter will be set to the false state, and a corresponding in or out parameter will be set to the true value. In case of an input initiative declined by the second or remote node, the transition parameter will be set to false. In this case, case the value of other parameters of the media-chat state will not change. That is, if after application A (the local node) initiates a chat, and in response, the remote node (application B) declines transition, local pending states are cancelled.

Output Message

During an active media-chat, the client shall send a media-message within the intervals of 7 seconds. Put another way, both nodes (i.e., both client applications) must exchange media-messages constantly while the media chat is active. This is a significant feature of the invention, i.e., how to protect the beneficiary from service being used without write-offs. At generation of a media-message, values of flow or stream states are determined by an expression <<local|pending>>, i.e., either the current state, or a switch on initiative (if any) will be sent to the second participant (i.e., the second or remote node). Transition of pending parameter into false parameter is a result of a state synchronization. Transition into false parameter is a result of a user action. If a pending feature would transfer to a true state, or a transition feature would transfer to a false state, then an unscheduled media-message shall be sent. If an attempt to send a media-message would result in a 402 error (which is part of the HTTP protocol described at https://www.w3.org/Protocols/rfc2616/rfc2616-sec10.html), the API shall transfer to the state of credits purchase. The client application presents the payments user interface to the user/client to enable the user/client to make a payment

Revisions A revision property is a realization of a Lamport clock. A Lamport timestamp algorithm determines the order of events in a distributed computer system. That is, as different nodes or processes are not necessarily synchronized, the Lamport timestamp algorithm provides a partial ordering of events with minimal overhead and conceptionally provides a starting point for a vector clock for a system of N processes embodying an array/vector of N logical clocks, one clock per process. Messages which are not finalizing and containing a less revision than a local one shall be ignored. Each message's revision is a “+1” to a previous message sent. If messages are somehow accepted by a recipient node (application) in reverse order, a second message that is being processed will have a revision that is lower that the revision of the message processed before, so the second message would be ignored (defined as stale”) Finalizing messages are an exception and shall be processed regardless of a revision. Finalizing messages are defined with the following state (In:0; out: 0; resync: 1), which means the other node or client application stopped the chat (call) and closed WebRTC connection. No synchronization is possible in this case, other than transmission to a closed state (in:0, out:0).

Media-Streams

If during synchronization of state or sending of the initiative (i.e., a first of local node initiating a media-message to a second or remote node), there is no active transfer of media stream, the outcoming media-message shall contain a network property. An exchange with media-messages with a network property results in establishment of a connection. In the network property, a media-message of the initiator contains a SDP-offer, and the recipient node's message contains an SDP-answer (SDP—Session Description Protocol).

At receipt or sending a media-message with switched off states of both media streams, or upon occurrence of hangup time moment from the last received media-message the peer-connection shall be interrupted. A sudden interruption of a peer-connection shall switch the media-chat state to pending-in=in, pending-out=out, in =0, out=0, with a sending of an unscheduled media-message. A switch on/off of the media stream results in an update of the connection (renegotiation) between the respective first (local) and second (remote) nodes. Update of the connection is performed during an exchange with media-messages containing SDP-offer and SDP-answer.

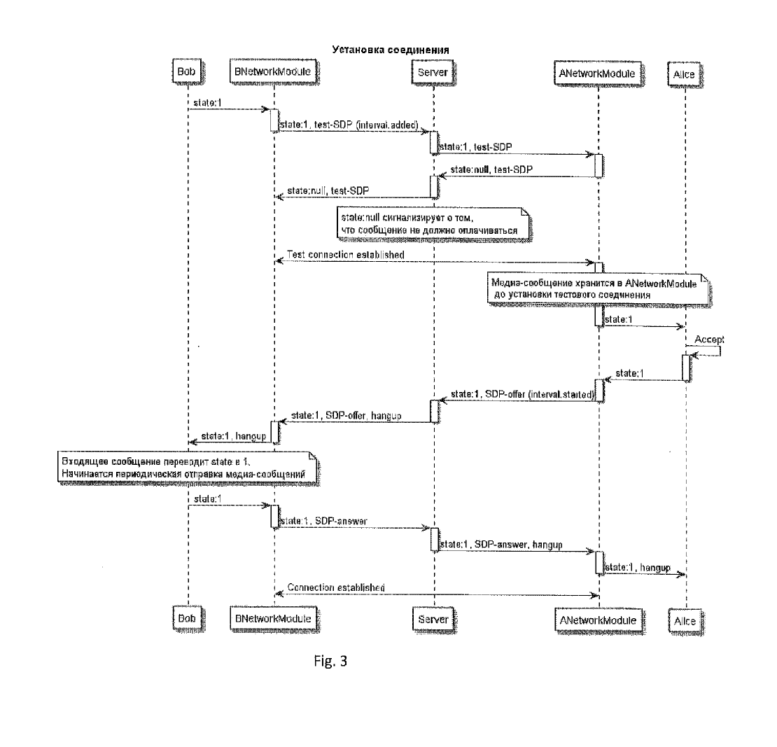

The signaling sequence for establishing a connection between a first (initiator) or local node and a second (recipient) or remote node is described in detail according to the signal flow chart of FIG. 3. In the FIG. 3 signaling sequence, Bob (Bob's electronic device) is the first or initiator node, which controls Bob's network module (BNetworkModule) as shown. The server as shown includes the inventive API and communicates with the Alice's network module (ANetworkModule), which is controlled by Alice (Alice's electronic device), i.e., the second or recipient node.

As will be evident to persons skilled in the art, the foregoing detailed description and figures are presented as examples of the invention, and that variations are contemplated that do not depart from the fair scope of the teachings and descriptions set forth in this disclosure. The foregoing is not intended to limit what has been invented, except to the extent that the following claims so limit that.

What is claimed is:

1. A system for enabling a direct exchange of streaming media between participants within a peer-to-peer network, the system comprising:
a plurality of network nodes that transmit media-messages to one another in node-to-node media-message exchanges defined as media-chats; and
a server operating an application programming interface (API) for receiving and processing a media-message transmitted by a first network node to a second network node, and based on the processing, directing the media-message to the second node to establish a media-chat therebetween and for monitoring and managing a media-chat state defined by respective sets of parameters for each of the network nodes;
wherein a synchronization of the respective media-chat states of the first node and the second node enables a direct streaming media exchange therebetween until one of the first network node and the second network changes a state of a parameter of the set of parameters, rendering the media-chat state of the first network node out of synchronization with the media-chat state of the second network node; and
wherein respective node accounts associated with the first network node and the second network node are charged for a time in which said nodes participate in the synchronized media-chat.

2. The system for enabling media-chats according to claim 1, wherein the first node and the second node periodically transmit media-messages in the synchronized media-chat state that are received by the API.

3. The system for enabling media-chats according to claim 2, wherein the API charges the node accounts of the first node and the second node as a function of a time of the synchronized media-chat state according to periodically transmit media-messages.

4. The system for enabling media-chats according to claim 1, wherein to initiate a media-chat with the second node, the first node transmits a media-message signal with a test-SDP (session description protocol), that the API receives and transmits the media-message signal with a test-SDP to the second node.

5. The system of enabling media chats according to claim 4, wherein the second node responds to the received media-message signal with a test-SDP by transmitting a return media-message signal, including the test-SDP and a null to the API, and wherein upon receipt, the API transmits the return media message signal to the first (initiating) node, establishing a test connection between the first node and the second node independent of the API.

6. The system of enabling media chats according to claim 5, wherein upon receipt of a media message signal defining establishment of the test connection, the second node accepts the media-chat initiated by the first node by transmitting an accept media-message signal with an SDP-offer to the first node.

7. The system of enabling media chats according to claim 6, wherein the API receives and modifies the accept media message signal with SDP-offer from the second node, to include a hangup, and transmits the accept media-message signal with the SDP-offer and hangup to first node.

8. The system of enabling media chats according to claim 7, wherein upon receipt of the accept media-message signal with the SDP-offer and hangup, the first node transmits an answer media-message signal with an SDP-answer to the second node.

9. The system of enabling media chats according to claim 8, wherein the API receives and modifies the answer media-message signal with an SDP-answer from the first node, to include a hangup and transmits the answer media-message signal with an SDP-answer and hangup to the second node, establishing a media stream connection between the first node and the second node that is independent of the API.

10. A method for monitoring media-chats between nodes in a peer-to-peer network, the monitoring in reliance upon a server-operated application programming interface (API), where upon a synchronization of two connected nodes participating in a media chat may directly exchange streaming media independent of the API, the method comprising the steps of:
transmitting a media-message signal from a local node to a remote node to initiate a media-chat with the remote node;
receiving and processing the media-message signal by the API, the API transmitting the media-message signal to the remote node as a test signal;
receiving the test signal by the remote node, the remote node modifying the test signal to add a null and transmitting the modified test signal;
receiving the modified test signal by the API, the API transmitting a test connection established signal to the local and remote nodes;
the remote node accepting the media-chat in response to the test connection established signal by transmitting an offer signal, starting an interval;
the API receiving the offer signal, modifying the offer signal with a hangup and transmitting the modified offer signal to the local node;
the local node responding to the modified offer signal by transmitting an answer signal; and
the API receiving the answer signal, modifying the answer signal with a hangup and transmitting the modified answer signal to the remote node, thereby establishing a media-chat connection between the local and remote nodes.

11. The method of claim 10, wherein the step of establishing the media-chat connection enables an exchange of streaming media between the local and remote nodes, independent of the API.

12. The method of claim 11, further including a step of exchanging streaming media, independent of the API.

13. The method of claim 12, further including modifying the media-chat parameters of the local and remote nodes to reflect synchronization therebetween.

14. The method of claim 13, wherein if one of the local and remote nodes cease transmitting streaming media, the API modifies the media-chat parameters to reflect an out-of-sync state.
